(19) United States
(12) Patent Application Publication
(10) Pub. No.: US 2012/0248088 A1
(43) Pub. Date: Oct. 4, 2012

(54) THERMAL SERVING TRAY

(76) Inventors: Colleen McMahon, Fredericksburg, VA (US); David J. McMahon, Fredericksburg, VA (US)

(21) Appl. No.: 13/073,669

(22) Filed: Mar. 28, 2011

(51) Int. Cl. H05B 1/00

(52) U.S. Cl. 219/387

(57) ABSTRACT

The thermal serving tray is a serving tray that can maintain either hot or cool temperatures relative to ambient temperature. The tray may have any desired shape or configuration, which may be rectangular, circular or any other shape, with no sidewalls, with walls that are substantially orthogonal or sloping, with or without handles, and with or without a lid or cover. Preferably, the bottom wall is hollow, in whole or in part, and encloses a thermal gel for keeping the tray and its contents warm or cool, as desired. A transparent window is formed in at least a portion of at least one wall of the tray so that a color change indicator is visible to indicate whether the temperature is either warm enough or cool enough to maintain the food at the desired temperature. The color change indicator may be layered above or intermixed with the thermal gel.

### BACKGROUND OF THE INVENTION

1. Field of the Invention

The present invention relates to food trays, and particularly to a thermal serving tray that can be used to keep food or other items at a desired temperature, either cool or warm.

2. Description of the Related Art

Food is often the centerpiece at social gatherings, such as picnics, BBQs, parties, or other outdoor events. Some foods should be served cold or chilled, while others should be kept warm. In order to have more time for socializing, the hosts will often try to buy or prepare the food well in advance, and then try to keep the food either chilled or warm, as appropriate, by keeping the food in the freezer or on a hot plate until ready for serving. Nevertheless, with conventional plates and dishes the food will often sit in the open for extended periods, either becoming too warm or too cool. Moreover, conventional plates or dishes are often not suitable for the freezer, with the result that some time is involved in transferring the food from a storage container to a serving dish. Thus, a thermal serving tray solving the aforementioned problems is desired.

### SUMMARY OF THE INVENTION

The thermal serving tray is a serving tray that can maintain either hot or cool temperatures relative to ambient temperature. The tray may have any desired shape or configuration, which may be rectangular, circular or any other shape, with no sidewalls, with walls that are substantially orthogonal or sloping, with or without handles, and with or without a lid or cover. Preferably, the bottom wall is hollow, in whole or in part, and encloses a thermal gel for keeping the tray and its contents warm or cool, as desired. A transparent window is formed in at least a portion of at least one wall of the tray so that a color change indicator is visible to indicate whether the temperature is either warm enough or cool enough to maintain the food at the desired temperature. The color change indicator may be layered above or intermixed with the thermal gel.

These and other features of the present invention will become readily apparent upon further review of the following specification and drawings.

### BRIEF DESCRIPTION OF THE DRAWINGS

FIG. 1 is an environmental perspective view of a first embodiment of a thermal serving tray according to the present invention.

FIG. 2 is a perspective view of the thermal serving tray of FIG. 1.

FIG. 3 is partial section view along lines 3-3 of FIG. 2.

FIG. 4 is a partial section view along lines 4-4 of FIG. 2.

FIG. 5 is a perspective view of a second embodiment of a thermal serving tray according to the present invention.

FIG. 6 is a perspective view of a third embodiment of a thermal serving tray according to the present invention.

FIG. 7A, FIG. 7B, and 7C are perspective views of fourth, fifth, and sixth embodiments, respectively, of a thermal serving tray according to the present invention.

Similar reference characters denote corresponding features consistently throughout the attached drawings.

### DETAILED DESCRIPTION OF THE PREFERRED EMBODIMENTS

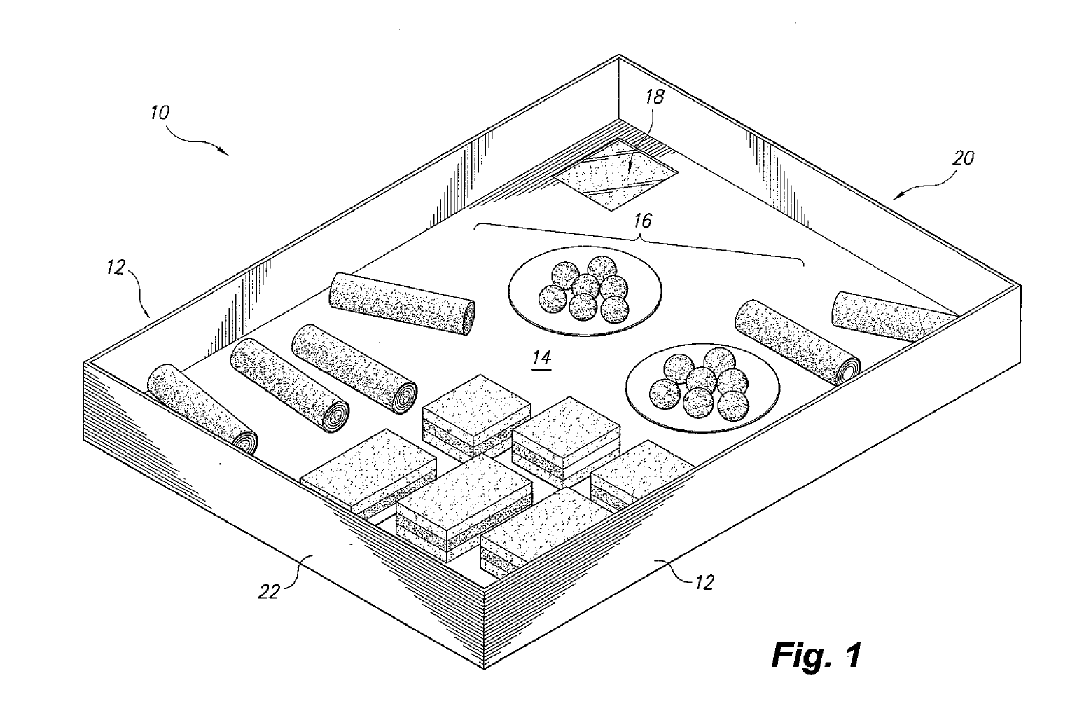

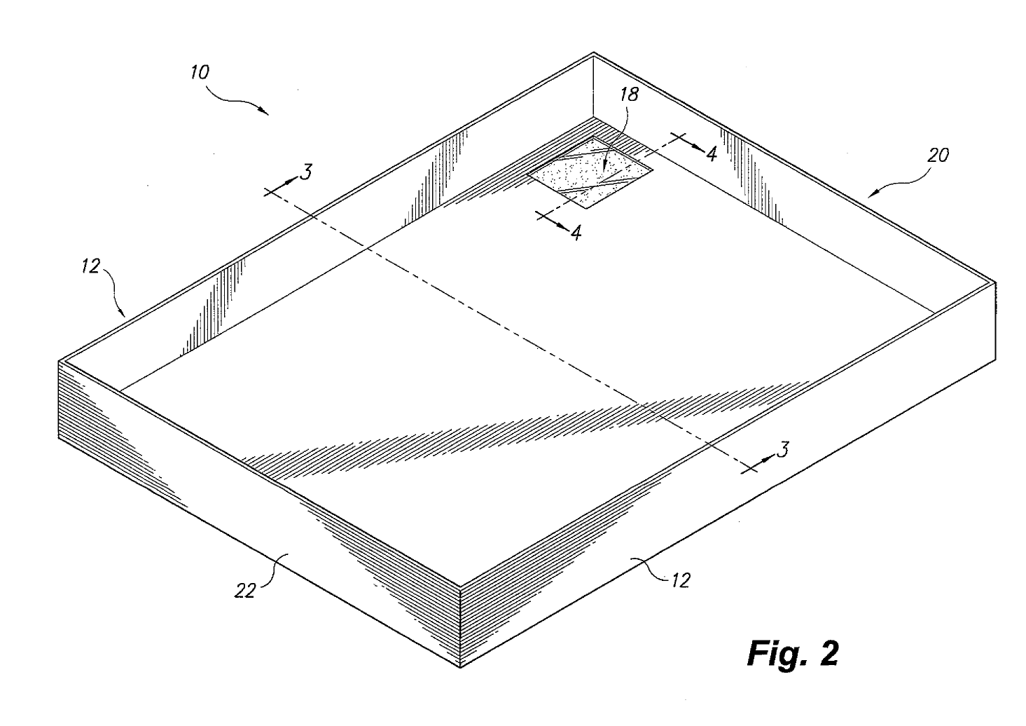

A first embodiment of a thermal serving tray, designated generally as 10 in the drawings, is shown in FIGS. 1-4. The tray 10 has a bottom wall 14, lateral sidewalls 12, a front wall 20, and a rear wall 22. In this embodiment, the front wall 20, rear wall 22, and lateral sidewalls 12 are each substantially orthogonal to the bottom wall 14. The tray 10 defines an open container for holding various items of food 16.

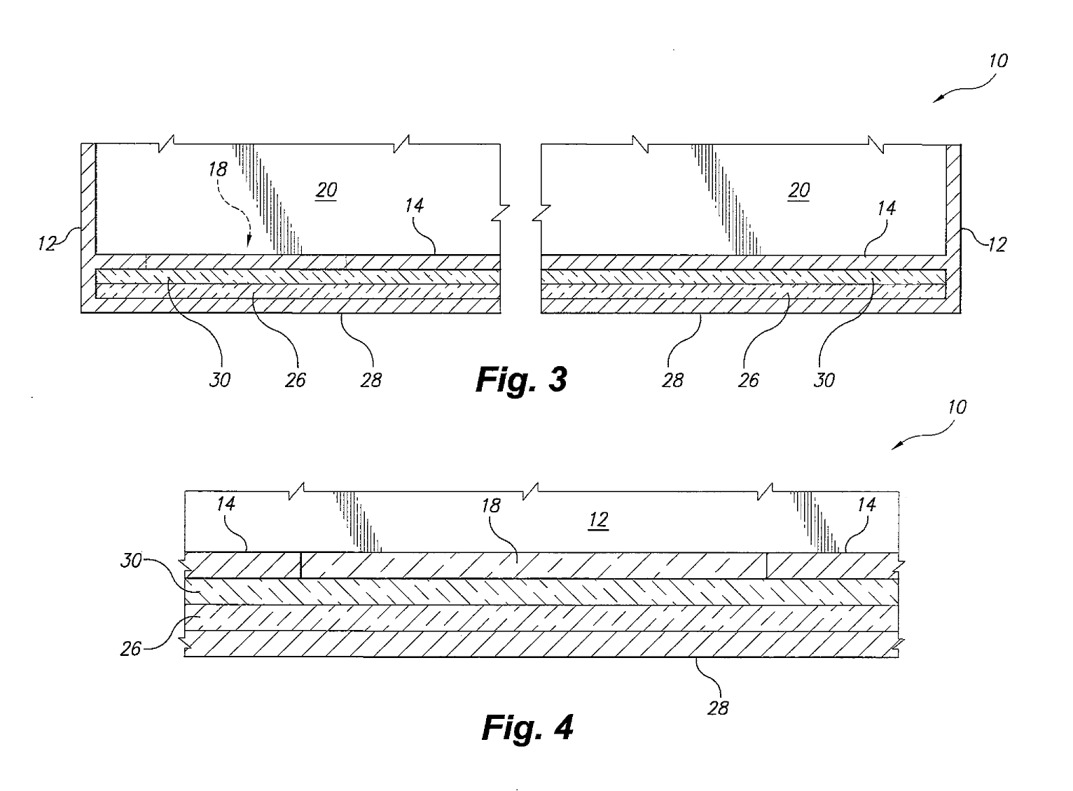

As shown in FIGS. 3 and 4, at least a portion of the bottom wall 14 is hollow, having a thermal gel or layer 26 and a color change indicator or layer 30 disposed in a compartment defined between the upper surface of the bottom wall 14 and the subfloor 28. In the drawings, the thermal gel 26 is shown to underlay the entire upper surface of the bottom wall 14. However, the thermal gel 26 need not underlay the entire bottom wall 14, particularly if the material forming the bottom wall 14 has sufficient thermal conductivity, but may be enclosed in a small compartment either within or atop the bottom wall 14.

The bottom wall 14 is shown having a transparent window 18 formed therein for viewing the color change indicator layer 30. The color change indicator is shown extending atop the entire extent of the layer of thermal gel 26. However, the color change indicator 30 need only overlay the thermal gel 26 in the area directly below the transparent window 18. Alternatively, the entire upper surface of the bottom wall 14 may be made from transparent material. The layer of color change indicator 30 may be disposed directly atop the layer of thermal gel 26, or may be separated therefrom by a membrane, thin film, or other partition, either flexible or rigid. Alternatively, the color change indicator 30 may be admixed with the thermal gel 26.

An example of such a color change or temperature-indicating gel suitable for use in the thermal serving tray 10 is a gel containing a block copolymer of polystyrene and poly (2-vinylpyridine). The shifts in color in the gel differ by as much as 575%, may occur in fractions of a second, and encompass the entire range of the light spectrum that the human eye can see, thus, making it highly suitable for use in the tray 10. Thermal gels for keeping the tray 10 warm or cold are well known in the art, and need not be described further. In some embodiments, a thermal liquid may be used instead of a thermal gel.

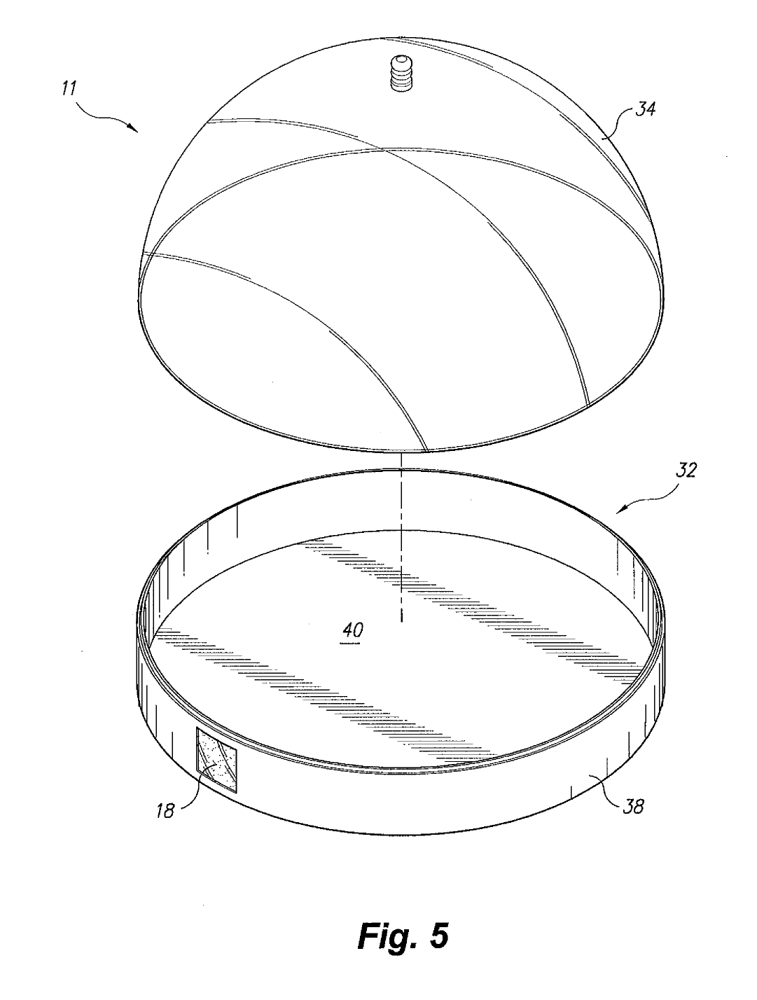

FIG. 5 shows an alternative embodiment of the thermal serving tray, designated generally as 11, in which the tray 11 is round, having a bottom wall 40 and a sidewall 38 defining an open container 32 having a removable lid or cover 34. In this embodiment, the transparent window 18 is shown disposed in the exterior of the sidewall 38. The gel 26 and color change indicator 30 are disposed in the bottom wall 14, but they may also be disposed within the sidewall 38, either within the entire periphery of the sidewall 38, or within a hollow pocket in the sidewall underlying the transparent window 18.

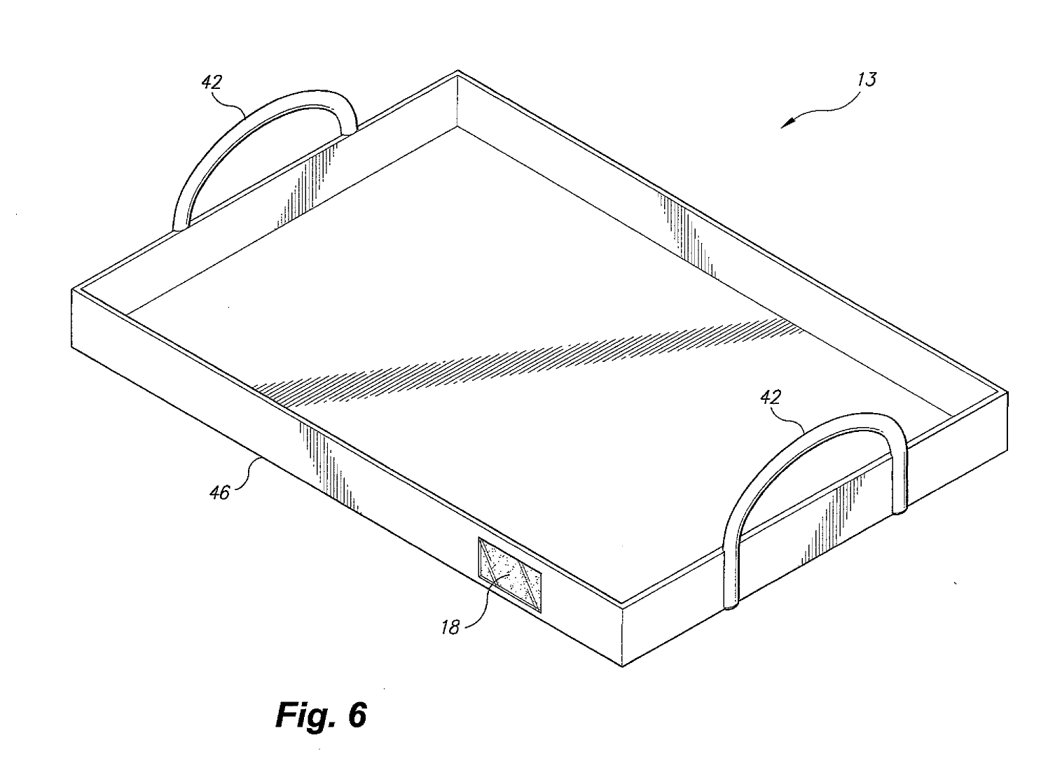

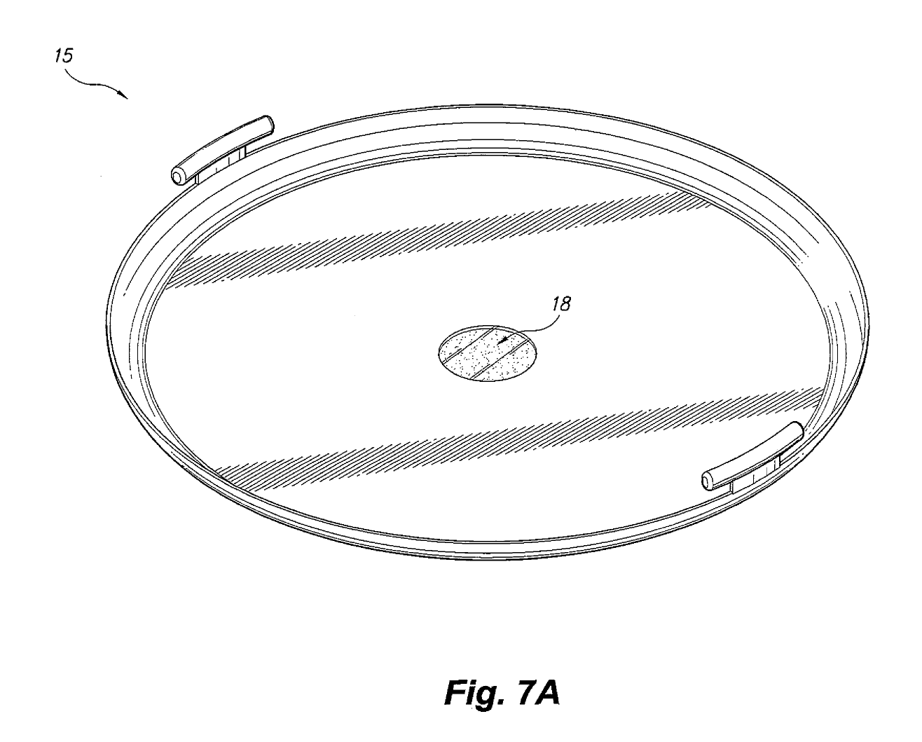

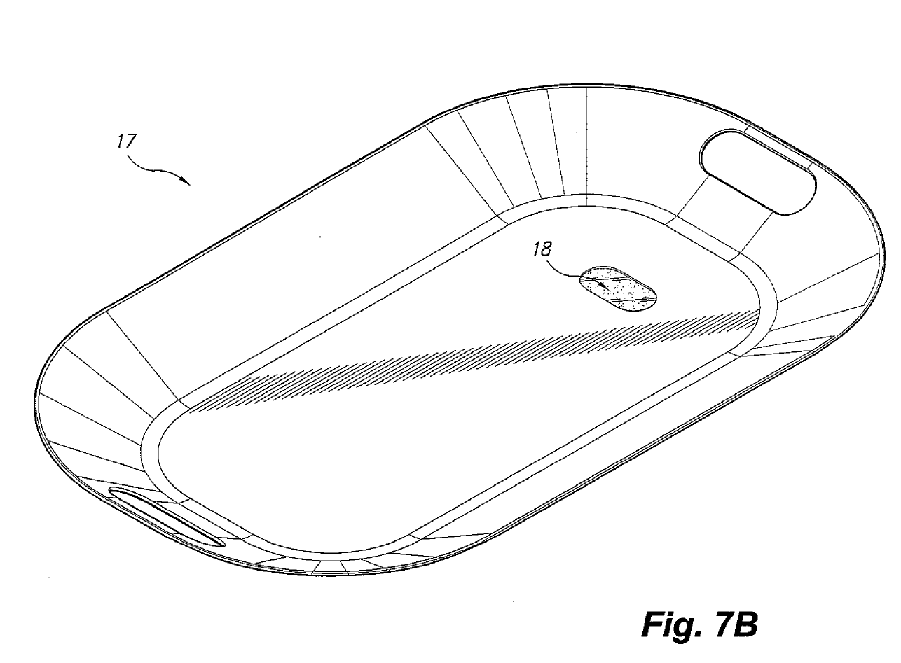

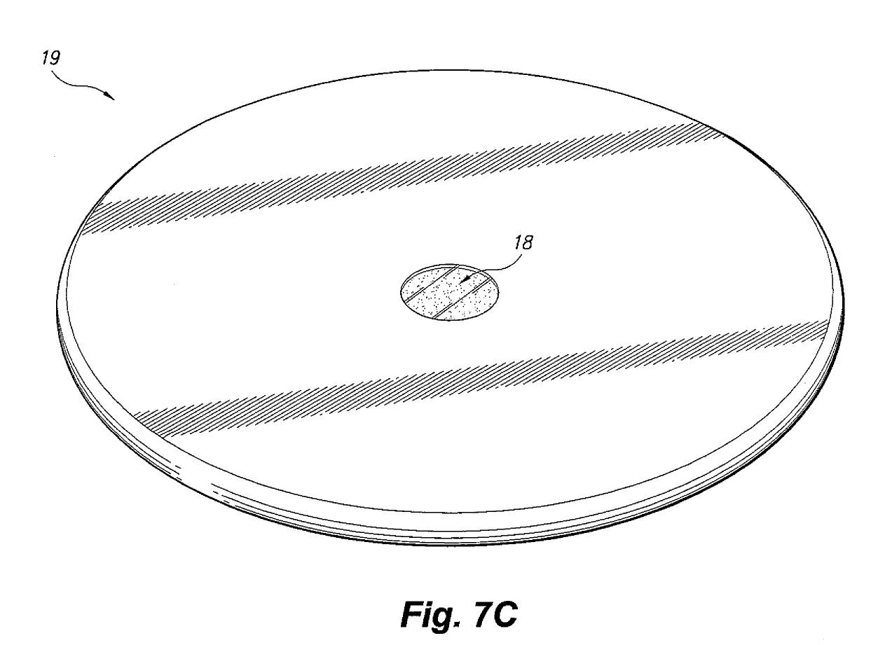

FIG. 6 displays another embodiment of the tray, designated as 13, similar to FIG. 1, but having handles 42 at opposite ends of the tray 13 and having the transparent window 18 defined in the sidewall 46. FIG. 7A depicts a round or circular tray 15 having sloping sidewalk and diametrically opposed handles. FIG. 7B depicts an oval or oblong tray 17 having sloping sidewalls and having handholds defined in the sidewalls of the tray 17. FIG. 7C depicts a circular tray 19 with no sidewalls or handles. It will be understood that each of the trays 11, 13, 15, 17 and 19 has a bottom wall similar in structure to the embodiment of FIGS. 1-4, i.e., a hollow bottom wall having a thermal gel disposed therein for keeping food warm or cold, and a transparent window 18 defined in at least a portion of either the bottom wall or a sidewall for viewing a color change or temperature indicator 30 that indicates whether the food is at the desired temperature. It is to be understood that while the transparent window depicted in the drawings represents only a portion of the surface on which it is disposed, the entire surface could be transparent. Alternatively, the temperature-indicating gel could be incorporated in such a manner as to form a portion of an outer surface so that no viewing window would be required.

It is to be understood that the present invention is not limited to the embodiments described above, but encompasses any and all embodiments within the scope of the following claims.

We claim:

1. A thermal serving tray, comprising:
a bottom wall defining a periphery, the bottom wall forming a tray adapted for serving food, the bottom wall being at least partially hollow and defining a compartment therein, the bottom wall being thermally conductive;
a thermal layer disposed in the compartment defined in the bottom wall, the thermal layer being capable of maintaining the tray at a desired temperature;
a transparent window formed on the tray; and
a color change temperature indicator disposed beneath the transparent window for providing a visual indicator that the food is at the desired temperature.

2. The thermal serving tray of 1, wherein said thermal layer comprises a layer of material selected from the group consisting of thermal gel and thermal liquid.

3. The thermal serving tray of claim 1, wherein said bottom wall is rectangular.

4. The thermal serving tray of claim 1, wherein said bottom wall is circular.

5. The thermal serving tray of claim 1, wherein said transparent window is defined in said bottom wall.

6. The thermal serving tray of claim 1, further comprising at least one sidewall extending upwardly around the periphery of said bottom wall, the at least one sidewall preventing food from rolling off said bottom wall.

7. The thermal serving tray of claim 6, wherein said bottom wall is circular.

8. The thermal serving tray of claim 7, wherein said transparent window is defined in said at least one sidewall.

9. The thermal serving tray of claim 6, wherein said bottom wall is rectangular.

10. The thermal serving tray of claim 9, wherein said transparent window is defined in said at least one sidewall.

11. The thermal serving tray of claim 1, wherein said color change temperature indicator comprises a layer of material configured to change color according to the temperature of the tray.

12. The thermal serving tray of claim 11, wherein the layer of material forming said color change temperature indicator comprises a block copolymer of polystyrene and poly (2-vinylpyridine).

13. A thermal serving tray, comprising:
a bottom wall defining a periphery and at least one sidewall extending around the periphery of the bottom wall, the bottom wall and the at least one sidewall forming a tray adapted for serving food, one of the walls being at least partially hollow and defining a compartment therein, the walls being thermally conductive;
a thermal gel disposed in the compartment, the gel being capable of maintaining the tray at a desired temperature;
a transparent window defined in the wall of the tray over the compartment; and
a color change temperature indicator disposed beneath the transparent window for providing a visual indicator that the food is at the desired temperature.

14. The thermal serving tray according to claim 13, wherein the color change temperature indicator comprises a gel containing a block copolymer of polystyrene and poly (2-vinylpyridine).

15. A thermal serving tray, comprising:
a bottom wall defining a periphery and at least one sidewall extending around the periphery, the bottom wall and the at least one sidewall forming a tray adapted for serving food, the bottom wall being at least partially hollow and defining a compartment therein, the walls being thermally conductive;
a thermal gel disposed in the compartment defined in the bottom wall, the gel being capable of maintaining the walls of the tray at a desired temperature;
a transparent window defined in at least a portion of one of the walls of the tray; and
a color change temperature indicator disposed beneath the transparent window for providing a visual indicator that the food is at the desired temperature.

16. The thermal tray of claim 15, wherein said at least one sidewall extends around the periphery of the bottom wall.

17. The thermal tray according to claim 15, wherein the color change temperature indicator comprises a gel containing a block copolymer of polystyrene and poly (2-vinylpyridine).

18. The thermal tray according to claim 15, wherein the color change temperature indicator is intermixed with the thermal gel.

19. The thermal tray according to claim 15, wherein the color change temperature indicator is layered above the thermal gel.
